(19) United States
(12) Patent Application Publication
(10) Pub. No.: US 2019/0017612 A1
(43) Pub. Date: Jan. 17, 2019

(54) VALVE DEVICE

(71) Applicant: DENSO CORPORATION, Kariya-city, Aichi-pref. (JP)

(72) Inventors: Tadashi IKEMOTO, Kariya-city (JP); Makoto SHIGEMATSU, Kariya-city (JP)

(21) Appl. No.: 16/068,686

(22) PCT Filed: Dec. 16, 2016
(86) PCT No.: PCT/JP2016/087506

§ 371 Date: Jul. 9, 2018

(30) Foreign Application Priority Data
Jan. 28, 2016 (JP) 2016-014483

(51) Int. Cl. F16K 11/087; F01P 7/14

(52) U.S. Cl. CPC F16K 11/0876; F01P 2007/146; F01P 7/14

(57) ABSTRACT

A rotary valve body has a first passage and changes a communication state between the first passage and a second passage. A housing has the second passage and defines a valve chamber in which a valve body is accommodated and in which the second passage is opened. A sealing member having a third passage is compressed between an outer surface of the valve body and an inner wall surface defining the valve chamber. The sealing member is in pressure contact with the outer surface of the valve body and the inner wall surface defining the valve chamber at a peripheral edge of an opening on one side of the third passage and at a peripheral edge of an opening on the other side, respectively. A diameter of the third passage is maximized at one of the opening on one side and the opening on the other side.

### CROSS REFERENCE TO RELATED APPLICATION

This application is based on Japanese Patent Application No. 2016-14483 filed on Jan. 28, 2016, the disclosure of which is incorporated herein by reference.

### TECHNICAL FIELD

The present disclosure relates to a valve device configured to increase or decrease a flow rate of a coolant for a vehicle internal combustion engine.

### BACKGROUND ART

Conventionally, a known valve device for increasing or decreasing a flow rate of a coolant in a vehicle internal combustion engine includes a valve body, a housing, and a sealing member described below. The valve body, which is of a spherical or cylindrical rotary type, has a first passage through which the coolant for the vehicle internal combustion engine flows, and is rotationally driven by a predetermined actuator to increase or decrease the flow rate of the coolant according to a rotation angle of the valve body.

The housing includes a second passage through which the coolant flows, and a valve chamber in which the valve body is rotatably accommodated and the second passage is opened. The sealing member includes a third passage for allowing the coolant to flow between the first passage and the second passage, and to restrict the coolant from leaking from each of the first passage, the second passage, and the third passage and the valve chamber.

In the valve device described above, a configuration has been known in which the sealing member is constantly pressed against an outer surface of the valve body by a spring (see, for example, Patent Literature 1). However, in the configuration of this type, there is a need to provide a spring that generates an urging force to urge the sealing member against the outer surface of the valve body, an 0-ring that secures a sealing property between the sealing member and the housing, and the like, which raises a concern about an increase in the number of components.

Under the above circumstances, a configuration having the sealing member as will be described below has been proposed. In this example, the sealing member is compressed and held between the outer surface of the valve body and an inner wall surface forming the valve chamber, and the sealing member is brought into pressure contact with the outer surface of the valve body and the inner wall surface of the valve chamber at peripheral edges of openings on one side and the other side of the third passage, respectively (see, for example, Patent Literature 2). However, with the configuration of the sealing member in Patent Literature 2, a fold (bellows) is provided in an axial center portion of the sealing member, and thus the sealing member has small diameter portions on both sides of a maximum diameter portion of an inner wall surface forming the third passage. The configuration would raise a concern about difficulty in removing a mold inside the fold during manufacturing state of the sealing member.

### PRIOR TECHNICAL LITERATURE

### Patent Literature

Patent Literature 1: JP2008-232260A

Patent Literature 2: JP2009-537761A

### SUMMARY OF INVENTION

It is an object of the present disclosure to provide a valve device having a configuration that facilitates removal of a sealing member from a mold.

According to one aspect of the present disclosure, a valve device is configured to be incorporated in a coolant circuit provided in a vehicle and is configured to be driven by an actuator to increase or decrease a flow rate of coolant for a vehicle internal combustion engine. The valve device comprises a valve body of a spherical or cylindrical rotary type that has a first passage to cause coolant to flow therethrough. The valve body is configured to be rotationally driven by the actuator to change a communication state between the first passage and a second passage according to a rotation angle of the valve body to increase or decrease a flow rate of coolant. The valve device further comprises a housing that has the second passage to cause coolant to flow therethrough and defines a valve chamber in which the valve body is rotatably accommodated and in which the second passage is opened. The valve device further comprises a sealing member that is compressed and held between an outer surface of the valve body and an inner wall surface defining the valve chamber. The sealing member has a third passage for allowing coolant to flow between the first passage and the second passage and for restricting leakage of coolant between each of the first passage, the second passage, and the third passage and the valve chamber. The sealing member is in pressure contact with the outer surface of the valve body and the inner wall surface of the valve chamber at a peripheral edge of an opening on one side of the third passage and at a peripheral edge of an opening on an other side, respectively. The peripheral edge of the opening on the one side is located around a locus of rotation of the opening of the first passage and is in pressure contact with the outer surface of the valve body while configured to be subjected to rotary sliding contact with the valve body. The peripheral edge of the opening on the other side is in pressure contact with the inner wall surface of the valve chamber to surround the opening of the second passage. A diameter of the third passage is maximized at one of the opening on the one side and the opening on the other side.

According to another aspect of the present disclosure, a valve device is configured to be incorporated in a coolant circuit provided in a vehicle and is configured to be driven by an actuator to increase or decrease a flow rate of coolant for a vehicle internal combustion engine. The valve device comprises a valve body of a spherical or cylindrical rotary type that has a first passage to cause coolant to flow therethrough. The valve body is configured to be rotationally driven by the actuator to change a communication state between the first passage and a second passage according to a rotation angle of the valve body to increase or decrease a flow rate of coolant. The valve device further comprises a housing that has the second passage to cause coolant to flow therethrough and defines a valve chamber in which the valve body is rotatably accommodated and in which the second passage is opened. The valve device further comprises a sealing member that is compressed and held between an outer surface of the valve body and an inner wall surface defining the valve chamber. The sealing member has a third passage for allowing coolant to flow between the first passage and the second passage and for restricting leakage of coolant between each of the first passage, the second passage, and the third passage and the valve chamber. The sealing member is in pressure contact with the outer surface of the valve body and the inner wall surface of the valve chamber at a peripheral edge of an opening on one side of the third passage and at a peripheral edge of an opening on an other side, respectively. The peripheral edge of the opening on the one side is located around a locus of rotation of the opening of the first passage and is in pressure contact with the outer surface of the valve body while configured to be subjected to rotary sliding contact with the valve body. The peripheral edge of the opening on the other side is in pressure contact with the inner wall surface of the valve chamber to surround the opening of the second passage. A diameter of the third passage is maximized at both of the opening on the one side and the opening on the other side.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an illustrative diagram showing a coolant control device for a vehicle internal combustion engine, in which a valve device is incorporated (first embodiment);

FIG. 2 is a cross-sectional view showing the valve device (first embodiment);

FIG. 3 is a cross-sectional view showing a sealing member (first embodiment);

(a) and (b) in FIG. 4 are illustrative diagrams of a method of holding the sealing member by a housing (first embodiment);

FIG. 5 is an illustrative view showing a valve body-side extension portion and a housing-side extension portion (first embodiment);

FIG. 6 is a cross-sectional view showing a sealing member (second embodiment);

FIG. 7 is a cross-sectional view showing a sealing member (third embodiment);

FIG. 8 is a cross-sectional view showing a sealing member (one modification);

FIG. 9 is a cross-sectional view showing a sealing member (another modification);

FIG. 10 is a cross-sectional view showing a sealing member (still another modification);

FIG. 11 is a cross-sectional view showing a sealing member (yet still another modification); and

(a), (b), and (c) in FIG. 12 are illustrative views of a method of fixing a sealing member by a housing (modification).

### DESCRIPTION OF EMBODIMENTS

Hereinafter, modes for carrying out the present disclosure will be described with reference to embodiments. It should be noted that the embodiments disclose specific examples and it is needless to say that the present disclosure is not limited to the embodiments.

### Configuration of First Embodiment

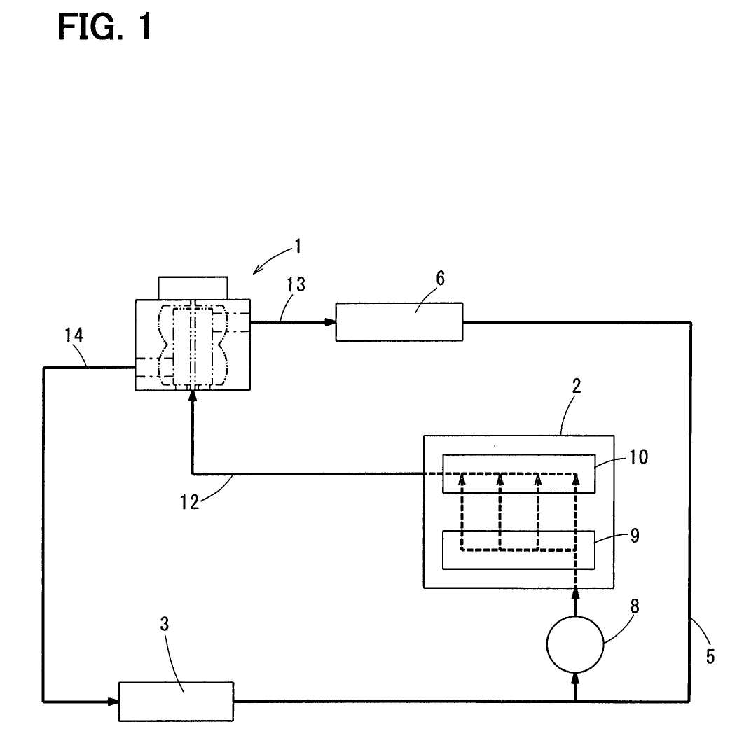

An overall configuration of a coolant control device for a vehicle internal combustion engine, in which a valve device 1 according to a first embodiment is incorporated, will be described with reference to FIG. 1.

The valve device 1 is used for a coolant circuit 5 in which a coolant for an internal combustion engine 2 circulates also in devices other than the internal combustion engine 2 and a radiator 3. In this example, for example, a heater core 6 is incorporated as another device in the coolant circuit 5, and a pump 8 is incorporated as a power source for circulating the coolant in the coolant circuit 5.

The pump 8 is, for example, an electric pump, and supplies the coolant for cooling a cylinder block 9 and a cylinder head 10 of the internal combustion engine 2 through the radiator 3, and also circulates the coolant to the heater core 6. The radiator 3 is a heat exchanger for cooling the coolant, and the heater core 6 is a heat exchanger for heating a vehicle interior with the coolant as a heat source. In this example, the coolant is pumped from the pump 8 and passes through the internal combustion engine 2, subsequently flows into the valve device 1, and circulates in the coolant circuit 5 so as to return to the pump 8 from the valve device 1 through one or both of the heater core 6 and the radiator 3.

The valve device 1 is incorporated in the coolant circuit 5 to increase or decrease a circulation flow rate of the coolant into the internal combustion engine 2 and the radiator 3 and to start and stop the circulation of the coolant to the heater core 6. The valve device 1 is connected to the internal combustion engine 2, the heater core 6, and the radiator 3 through flow channels 12 to 14, respectively. In this example, the flow channel 12 leads the coolant from the internal combustion engine 2 to the valve device 1. The flow channel 13 leads the coolant from the valve device 1 to the heater core 6, and the flow channel 14 leads the coolant from the valve device 1 to the radiator 3.

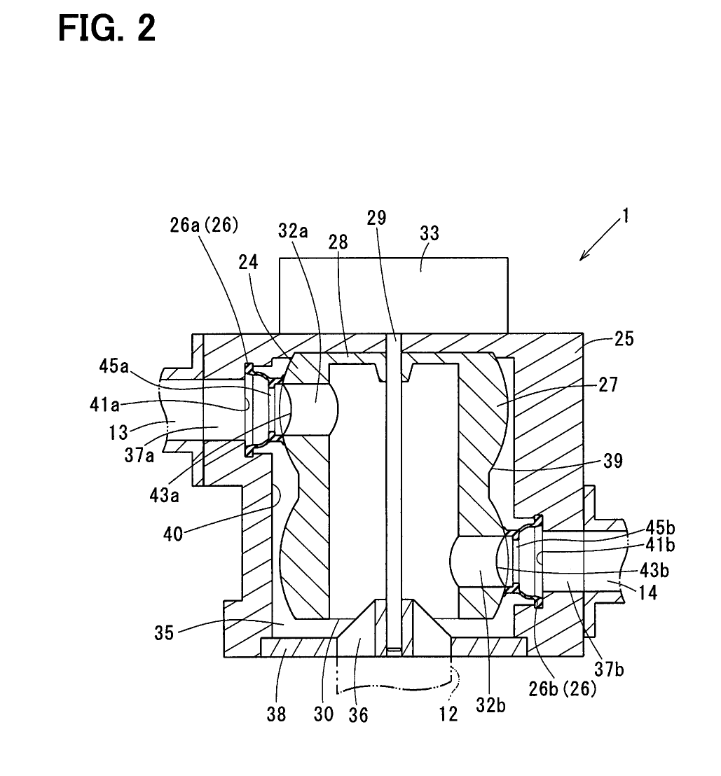

The valve device 1 will be described with reference to FIG. 2. In the description of FIG. 2, an upper side and a lower side in the drawing may be referred to as “upper” and “lower” in some cases.

The valve device 1 includes a valve body 24, a housing 25, and a sealing member 26, which will be described below. The valve body 24 is a cylindrical body whose upper end is closed, and includes a cylindrical portion 27 and a closed portion 28. In this example, the closed portion 28 is connected and integrated with a shaft portion 29 to be rotationally driven, and the valve body 24 is enabled to rotate together with the shaft portion 29. The valve body 24 has an opening portion 30 at a lower end. In this example, an internal space of the valve body 24 defines a space through which the coolant flows.

In the cylindrical portion 27, first passages 32a and 32b, through which the coolant flows, are present in two vertically separated positions to penetrate in a radial direction. In this example, the first passage 32a is provided on an upper side, and the first passage 32b is provided on a lower side.

The shaft portion 29 is rotationally driven by an electric motor 33 or the like, which is a predetermined actuator, whereby the valve body 24 rotates about the shaft portion 29. It should be noted that the electric motor 33 and the like receive a command from an ECU (not shown) or the like and rotationally operates the valve body 24. The valve body 24 is a spherical valve body of a rotary type whose outer surface shape has spherical convex portions continuous in a vertical direction, in which the first passages 32a and 32b are opened in the spherical convex portions.

The housing 25 rotatably accommodates the valve body 24. The housing 25 has a valve chamber 35 having a columnar hole for accommodating the valve body 24, a passage 36 that extends downward from a lower end of the valve chamber 35, through which the coolant flows, and second passages 37a and 37b that extend in a radial direction of the valve chamber 35, through which the coolant flows. A component 38 located at a lower end of the housing 25 in which the passage 36 is defined is another component different from a portion where the second passages 37a and 37b are defined.

In this example, the passage 36 communicates with the flow channel 12, and the second passages 37a and 37b communicate with the flow channels 13 and 14, respectively. The second passage 37a is located on an upper side of the housing 25, and the second passage 37b is located on a lower side of the housing 25. Gaps are formed between an outer surface 39 of the valve body 24 and an inner wall surface 40 of the valve chamber 35, respectively. An interior of the valve chamber 35 is constantly filled with the coolant or the like flowing out from the first passages 32a and 32b.

The second passage 37a is provided so that an opening 41a that opens to the inner wall surface 40 of the second passage 37a and an opening 43a that opens to the outer surface 39 of the first passage 32a overlap with each other due to the rotation of the valve body 24. Similarly, the second passage 37b is provided so that rotation of the valve body 24 causes an opening 41b open to the inner wall surface 40 of the second passage 37b and an opening 43b open to the outer surface 39 of the first passage 32b to overlap with each other.

Further, the passage 36 communicates with an internal space of the valve body 24 through the opening portion 30, and thus the coolant is introduced into the valve body 24. Subsequently, when the valve body 24 is rotationally driven, a communication state between the first passages 32a and 32b and the second passages 37a and 37b is changed according to the rotation angle of the valve body 24, to thereby increase or decrease a flow rate of the coolant to the radiator 3 and the like.

The sealing member 26 is made of, for example, cylindrical EPDM (ethylene-propylene-diene rubber), and is compressed and held between the outer surface 39 and the inner wall surface 40. In the following description, the upper sealing member 26 having the third passage 45a through which the coolant flows between the first passage 32a and the second passage 37a may be referred to as a sealing member 26a. In addition, the lower sealing member 26 having the third passage 45b through which the coolant flows between the first passage 32b and the second passage 37b may be referred to as a sealing member 26b.

Herein, the sealing member 26a restricts the leakage of the coolant between each of the first passage 32a, the second passage 37a, and the third passage 45a and the valve chamber 35, and the sealing member 26b restricts the leakage of the coolant between each of the first passage 32b, the second passage 37b, and the third passage 45b and the valve chamber 35.

Further, the sealing member 26a is held by the housing 25 such that the second passage 37a and the third passage 45a constantly communicate with each other and the second passage 37a and the third passage 45a are coaxial with each other. Similarly, the sealing member 26b is held by the housing 25 such that the second passage 37b and the third passage 45b constantly communicate with each other and the second passage 37b and the third passage 45b are coaxial with each other.

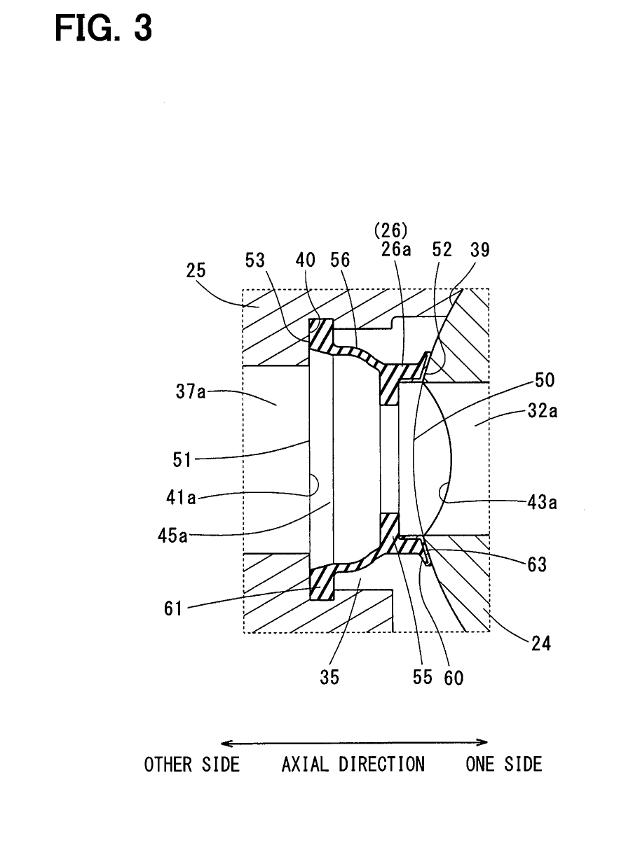

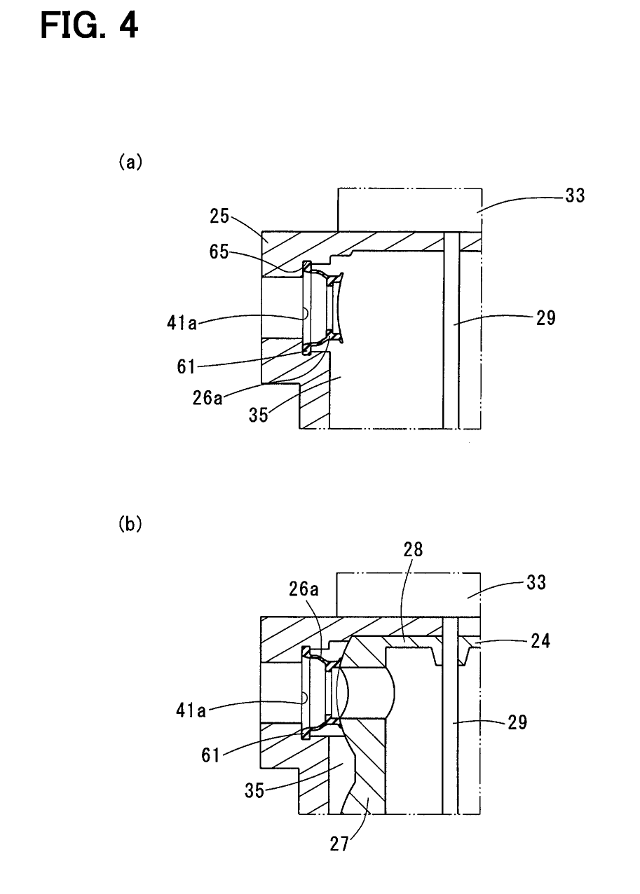

As follows, the sealing member 26 will be described with reference to FIG. 3. In FIG. 3, the sealing member 26a is taken as an example, but the same applies to the sealing member 26b. The sealing member 26a is brought into pressure contact with the outer surface 39 of the valve body 24 and the inner wall surface 40 of the valve chamber 35 at peripheral edges 52 and 53 of openings 50 and 51 on one side of the third passage 45a and on the other side of the third passage 45a, respectively. Hereinafter, a direction of the axis of the sealing member 26a is defined as an axial direction, a direction of the diameter is defined as a radial direction, a side of the sealing member 26a which is brought into pressure contact with the outer surface 39 is defined as one side, and a side of the sealing member 26a which is brought into pressure contact with the inner wall surface 40 is defined as the other side.

The peripheral edge 52 of the opening 50 on one side is located around a locus of rotation of the opening 43a of the first passage 32a and is brought into pressure contact with the outer surface 39 of the valve body 24 while being subjected to rotary sliding contact with the valve body 24. The peripheral edge 53 of the opening 51 on the other side is brought into pressure contact with the inner wall surface 40 of the valve chamber 35 so as to surround the opening 41a of the second passage 37a. A diameter of the third passage 45a is maximized at the opening 51 on the other side.

In addition, the radial thickness of the sealing member 26a varies according to the axial position of the sealing member 26a. More specifically, the sealing member 26a has a thickest portion 55 whose thickness is maximum in the radial direction on the other side of the opening 50. The sealing member 26a has a thinnest portion 56 whose thickness is minimum in the radial direction on the other side of the thickest portion 55. The thickest portion 55 and the thinnest portion 56 are annular portions having substantially the same thickness in the radial direction. A diameter of the inner wall surface of the thickest portion 55 is a minimum diameter portion of the third passage 45a. The thinnest portion 56 is located between both axial ends.

The sealing member 26a has a valve body-side extension portion 60 that extends radially outward from the peripheral edge 52 of the opening 50 on one side along the outer surface 39. The sealing member 26a has a housing-side extension portion 61 that extends radially outward from the peripheral edge 53 of the opening 51 on the other side along the inner wall surface 40. More specifically, the valve body-side extension portion 60 and the housing-side extension portion 61 are annular portions having substantially the same thickness in the radial direction.

In addition, in the sealing member 26a, the peripheral edge 52 of the opening 50 on one side is made of fluororesin 63. In this example, the fluororesin 63 is, for example, PTFE (polytetrafluoroethylene), PFA (tetrafluoroethylene-perfluoroalkyl vinyl ether copolymer), or FEP (tetrafluoroethylene-hexafluoropropylene copolymer). Further, the fluororesin 63 extends to an inner wall of the third passage 45a. More specifically, an annular thin plate made of fluororesin having a curved cross section is embedded in a surface of the sealing member 26a.

The fluororesin 63 may be formed by coating.

As follows, a specific example of a method of holding the sealing member 26a by the housing 25 will be described with reference to FIG. 4. First, the sealing member 26a is inserted into the valve chamber 35 from the lower side in FIG. 2, and an outer peripheral edge of the housing-side extension portion 61 is fitted into an annular groove 65 provided so as to surround the opening 41a (see (a) in FIG. 4). At that time, the component 38 at the lower end of the housing 25 where the passage 36 is provided as described above is another component different from the portion of the housing 25 in which the second passages 37a and 37b are defined (see FIG. 2). Therefore, the component 38 is configured to be removed, and work is enabled in a state where the lower end of the housing 25 is opened.

Next, the valve body 24 is inserted into the valve chamber 35 from the lower side in FIG. 2, the shaft portion 29 is inserted through an insertion hole provided in the closed portion 28, and the shaft portion 29 is fixed to the closed portion 28 with a screw or the like. At that time, the valve body 24 is fixed so that the sealing member 26a is compressed in the axial direction (see (b) in FIG. 4). The component 38 is fixed, by screw fastening or the like, to a lower end of a portion of the housing 25 in which the second passages 37a and 37b are provided (see FIG. 2).

### Effects of First Embodiment

According to the valve device 1 of the first embodiment, the diameter of the third passage 45a is maximized at the opening 51 on the other side. As a result, the diameter of the inner wall surface of the sealing member 26a in which the third passage 45a is defined is maximum at the other end, and thus mold is easily removed on the other axial side. For that reason, the valve device 1 for increasing or decreasing the flow rate of the coolant of the vehicle internal combustion engine is configured such that the mold is enabled to be easily removed from the sealing member 26a.

In the first embodiment, the inner wall surface of the thickest portion 55 has the minimum diameter, but the diameter of the third passage 45a on one side is also greatly enlarged from the minimum diameter portion. For that reason, the mold may be divided on the radially inside of the thickest portion 55, so that the mold may also be removed on one side. Even if the diameter of the inner wall surface of the thinnest portion 56 on the other side is small, the thinnest portion 56 may be deformed so that the mold may be removed on the other side because the thinnest portion 56 is thin in the radial direction.

According to the valve device 1 of the first embodiment, the radial thickness of the sealing member 26a varies according to the axial position of the sealing member 26a. As a result, the sealing member 26a has thick and thin portions in the radial direction.

This example enables to reduce the thickness of the sealing member 26a in the radial direction, which makes it possible to reduce a force with which the sealing member 26a is brought into pressure contact with the outer surface 39 of the valve body 24. For that reason, the configuration enables to reduce a rotational driving force of the valve body, and enables to downsize the electric motor 33 and the like. In addition, with an increase in the thickness in the radial direction, the configuration enables to restrict the sealing member 26a from being deformed due to the water pressure of the coolant. For that reason, the configuration enables to restrict the deformation of the sealing member 26a, and therefore to restrict a gap from being formed between the outer surface 39 and the inner wall surface 40. Thus, the configuration enables to secure the sealing property of the sealing member 26a.

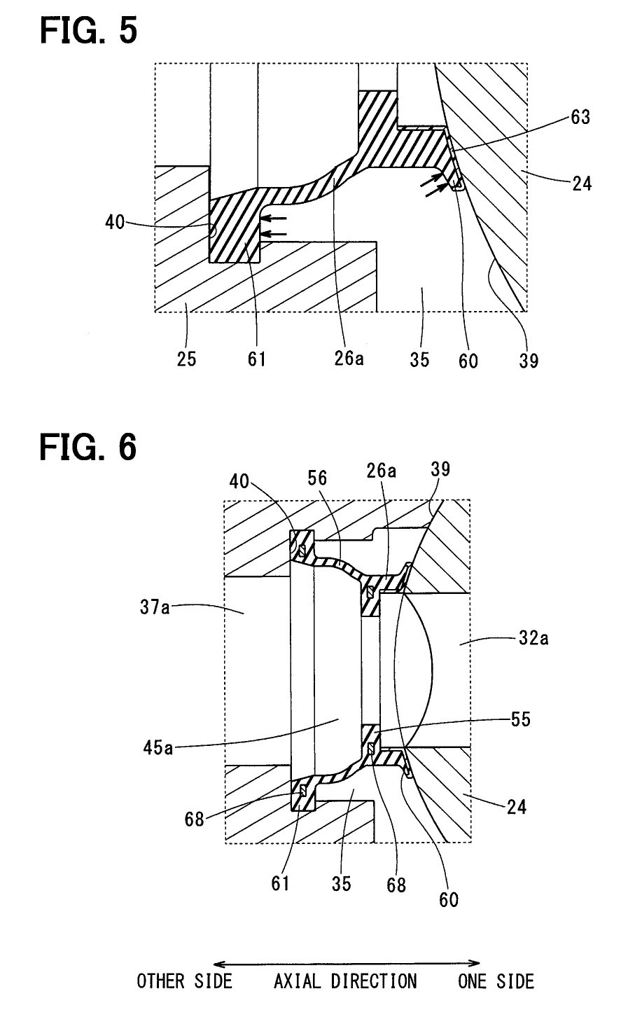

According to the valve device 1 of the first embodiment, the sealing member 26a has a valve body-side extension portion 60 that extends radially outward from the peripheral edge 52 of the opening 50 on one side along the outer surface 39 of the valve body 24. As a result, the valve body-side extension portion 60 is subjected to the water pressure of the coolant and sticks to the outer surface 39, thereby being enable to enhance the close contact of the sealing member 26a to the valve body 24 and to enhance the sealing property of the sealing member 26a (see FIG. 5).

According to the valve device 1 of the first embodiment, the sealing member 26a has a housing-side extension portion 61 that extends radially outward from the peripheral edge 53 of the opening 51 on the other side along the inner wall surface 40 of the valve chamber 35. As a result, the housing-side extension portion 61 is subjected to the water pressure of the coolant and sticks to the inner wall surface 40, thereby being enabling to enhance the close contact of the sealing member 26a to the inner wall surface 40 and to enhance and the sealing property of the sealing member 26a (see FIG. 5). In FIG. 5, arrows indicate directions of the water pressure applied to the sealing member 26a by the coolant in the valve chamber 35.

In addition, according to the valve device 1 of the first embodiment, in the sealing member 26a, the peripheral edge 52 of the opening 50 on one side is made of fluororesin 63. As a result, the configuration enables to reduce a frictional force between the valve body 24 and the sealing member 26a, and further to reduce the rotational driving force of the valve body 24. Thus, the configuration enables to downsize the electric motor 33 and the like.

Further, according to the valve device 1 of the first embodiment, the fluororesin 63 extends to the inner wall of the third passage 45a of the sealing member 26a and the outer wall of the sealing member 26a. As a result, the fluororesin 63 is fixed to the sealing member 26a not only on the peripheral edge 52 of the opening 50 on one side but also on the inner wall and the outer wall of the third passage 45a, and thus the fixed area for the sealing member 26a is increased. For that reason, the fluororesin 63 is less likely to peel off from the sealing member 26a. In addition, since the fluororesin 63 has higher rigidity than EPDM, the rigidity of the sealing member 26a can also be increased.

### Second Embodiment

A valve device 1 according to a second embodiment will be described with reference to FIG. 6 with emphasis on portions different from the first embodiment. In the following embodiment, the same functional components as those of the first embodiment are denoted by the same reference numerals. According to the valve device 1 in the second embodiment, a sealing member 26a is embedded with metal rings 68 that are closed over an entire circumference so as to surround a third passage 45a.

In this example, the metal rings 68 are annular and embedded in two places: the thickest portion 55 and the housing-side extension portion 61. In addition, the cross-sectional shape of each metal ring 68 is a substantially rectangular shape longer in the radial direction. With the above configuration, the rigidity of the sealing member 26a can be increased, and deformation of the sealing member 26a due to the water pressure of the coolant can be restricted.

In the valve device 1 according to the second embodiment, the respective metal rings 68 are located entirely outside the inner wall surface forming the third passage 45a. As a result, the metal rings 68 do not protrude toward the inner wall side of the third passage 45a, and thus the metal rings 68 do not affect the mold removal for the sealing member 26a.

### Third Embodiment

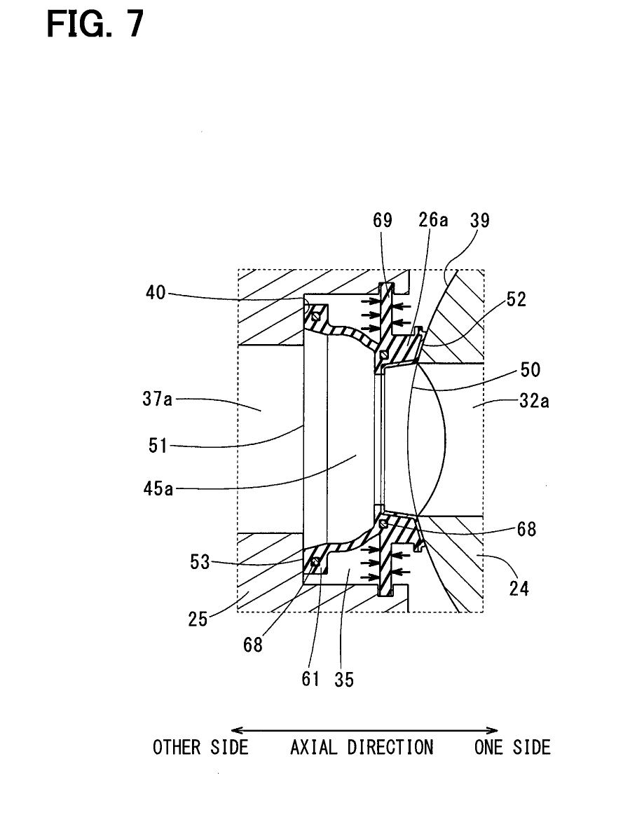

A valve device 1 according to a third embodiment will be described with reference to FIG. 7 with emphasis on portions different from the second embodiment. In the valve device 1 according to the third embodiment, a sealing member 26a has an intermediate extension portion 69 that extends outward in a radial direction of a third passage 45a between a peripheral edge 52 of an opening 50 on one side and a peripheral edge 53 of an opening 51 on the other side. An area of a portion of the intermediate extension portion 69 exposed to a valve chamber 35 on a housing 25 side is equal to or larger than an area of that on a valve body 24 side.

As a result, the intermediate extension portion 69 is subjected to a water pressure of a coolant in the valve chamber 35 and pressed toward the valve body 24 side, thereby being enabling to enhance the close contact of a sealing member 26a to the valve body 24 and to enhance the sealing property. Further, since the intermediate extension portion 69 is a portion protruding radially outward, the intermediate extension portion 69 can be fitted into a groove or the like provided in the housing 25.

In the sealing member 26a of the third embodiment, the valve body-side extension portion 60 is omitted and replaced with the intermediate extension portion 69. In addition, cross-sectional shapes of the two metal rings 68 are both circular. In the figure, arrows indicate directions of the water pressure applied to the sealing member 26a by the coolant in the valve chamber 35.

### Modifications

Various modifications of the present disclosure can be considered without departing from the spirit of the present disclosure.

In the first to third embodiments, the valve body 24 is a spherical rotary valve body whose outer surface shape is a spherical convex portion, but the valve body 24 may be a rotary valve body having a cylindrical outer surface shape.

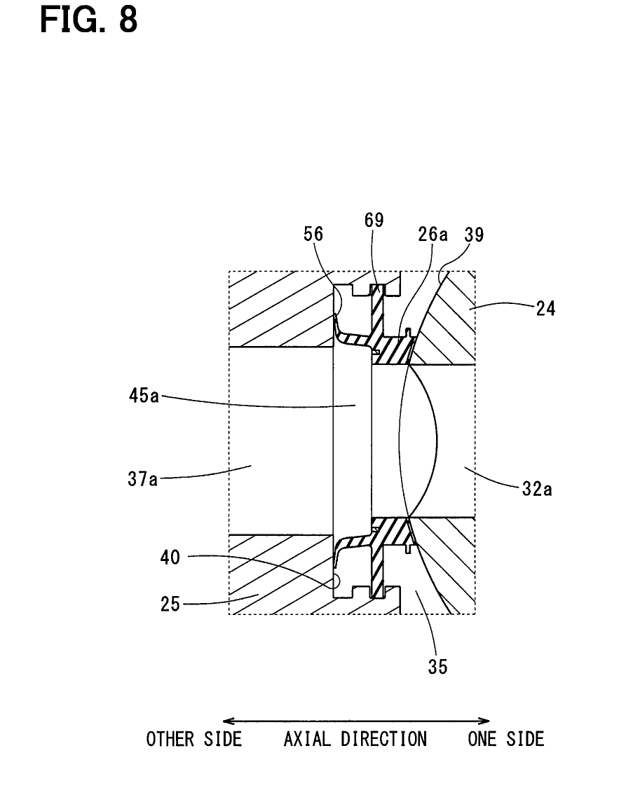

In the first to third embodiments, the thinnest portion 56 of the sealing member 26a is located between both axial ends. However, for example, the thinnest portion 56 may be provided at the other end as shown in FIG. 8. Further, the thinnest portion 56 may be provided at one end of the sealing member 26a, or the thinnest portion 56 may be provided at both ends of the sealing member 26a.

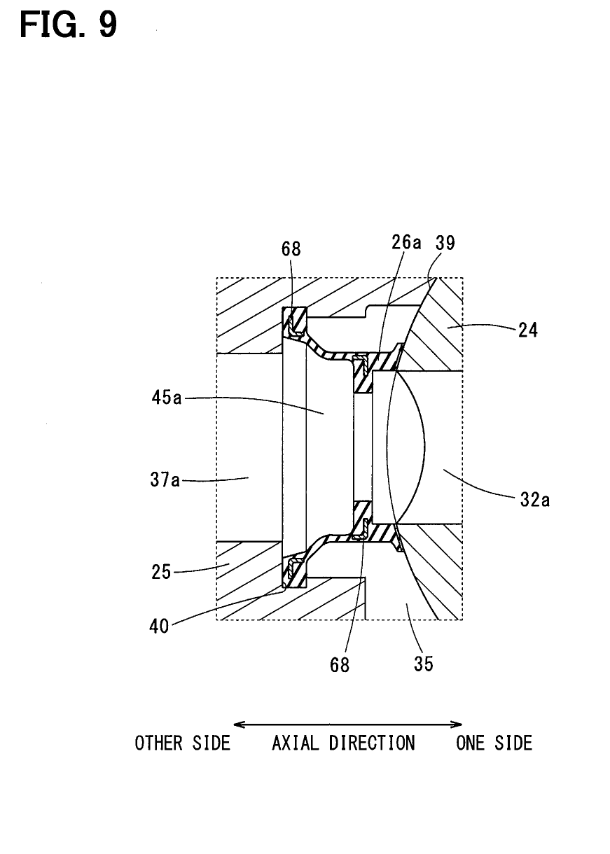

In the second embodiment, the metal rings 68 are substantially rectangular in cross-section, but as shown in FIG. 9, the metal rings 68 may have a bent cross-sectional configuration. In FIG. 9, the cross-sectional shape of the metal rings 68 is substantially L-shaped. With the above configuration, the rigidity of the metal rings 68 can be increased, and the deformation of the sealing member 26a due to the water pressure of the coolant can be further restricted.

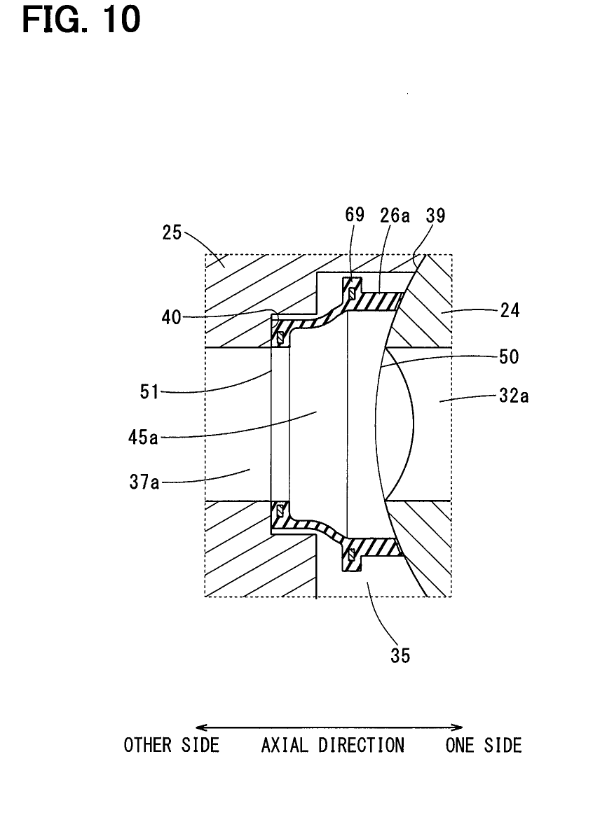

In the first to third embodiments, the diameter of the third passage 45a is maximized at the opening 51 on the other side, but as shown in FIG. 10, the opening 50 on one side may have the maximum diameter. Further, the diameter of the third passage 45a may be maximized at both of the openings 50 and 51 on one side and the other side.

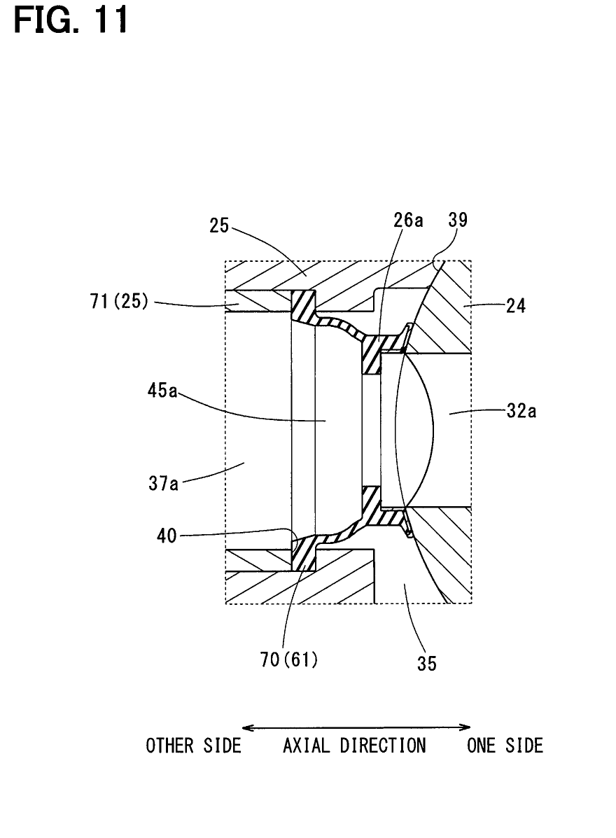

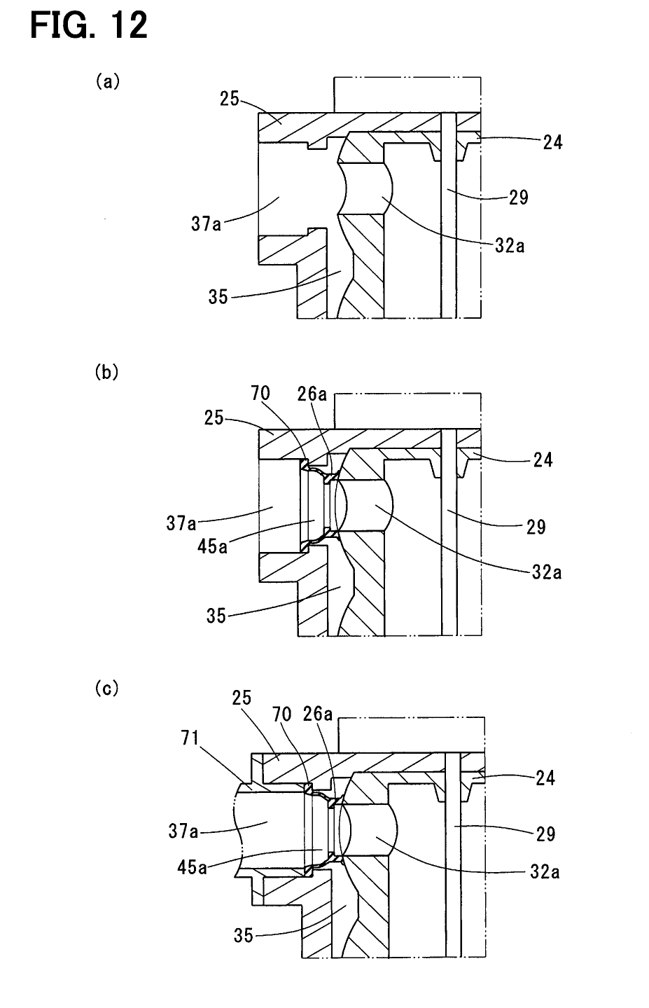

In the first to third embodiments, the housing-side extension portion 61 (hereinafter referred to as a flange 70) of the sealing member 26a is not fixed to the housing 25, but as shown in FIG. 11, the sealing member 26a may be fixed to the housing 25 by being sandwiched between components of the housing 25. As a result, deformation of the flange 70 of the sealing member 26a is restricted. For that reason, the deformation of the sealing member 26a due to the water pressure of the coolant can be restricted.

In this example, a specific example of a method of fixing the flange 70 to the housing 25 is shown in FIG. 12. First, the sealing member 26a is fitted into the valve chamber 35 through the second passage 37a in a state where the valve body 24 is fixed to the shaft portion 29 (see (a) in FIG. 12), and one side of the flange 70 is abutted against an annular protruding portion that protrudes toward the radially inside of the second passage 37a (see (b) in FIG. 12).

Next, a pipe member 71 whose diameter is smaller than the diameter of the inner wall surface of the second passage 37a is fitted into the second passage 37a from the second passage 37a, and an end of the pipe member 71 is abutted against the other side of the flange 70. Subsequently, the pipe member 71 is fixed to the housing 25 in a state where the flange 70 is sandwiched between the protruding portion of the housing 25 and the pipe member 71, as a result of which the pipe member 71 configures a part of the second passage 37a (see (c) in FIG. 12).

The pipe member 71 is fixed to the housing 25 by screw fastening or the like. At that time, the sealing member 26a is compressed in the axial direction by the housing 25 and the valve body 24, and the flange 70 is sandwiched between the components forming the housing 25, that is, the protruding portion of the housing 25 and the pipe member 71.

The valve device described above includes a valve body, a housing, and a sealing member, which will be described below. The valve body, which is of a spherical or cylindrical rotary type, has a first passage through which the coolant for the vehicle internal combustion engine flows, and is rotationally driven by a predetermined actuator to increase and decrease the flow rate of the coolant according to a rotation angle of the valve body. The housing includes a second passage through which the coolant flows, and a valve chamber in which the valve body is rotatably accommodated and the second passage is opened.

The sealing member is compressed and held between an outer surface of the valve body and an inner wall surface which defines the valve chamber, includes a third passage for allowing the coolant to flow between the first passage and the second passage, and restricts the coolant from leaking from between the first passage, the second passage, and the third passage and the valve chamber. The sealing member is brought into pressure contact with the outer surface of the valve body and the inner wall surface of the valve chamber at peripheral edges of openings on one side and the other side of the third passage, respectively.

In this example, the peripheral edge of the opening on one side is located in the rotation locus of the opening of the first passage and is in pressure contact with the outer surface of the valve body while being subjected to rotary sliding contact with the valve body. The peripheral edge of the opening on the other side is in pressure contact with the inner wall surface of the valve chamber so as to surround the opening of the second passage. A diameter of the third passage is maximized at one of the opening on one side and the opening on the other side.

As a result, the diameter of the inner wall surface of the sealing member in which the third passage is defined is maximum at the end, and thus the mold is easily removed in the axial direction. For that reason, the valve device for increasing or decreasing the flow rate of the coolant of the vehicle internal combustion engine is configured such that the sealing member can be easily removed from the mold.

The coolant control valve device described above includes a valve body, a housing, and a sealing member, which will be described below. The valve body, which is of a spherical or cylindrical rotary type, has a first passage through which the coolant for the vehicle internal combustion engine flows, and is rotationally driven by a predetermined actuator to increase and decrease the flow rate of the coolant according to a rotation angle of the valve body. The housing includes a second passage through which the coolant flows, and a valve chamber in which the valve body is rotatably accommodated and the second passage is opened.

The sealing member is compressed and held between an outer surface of the valve body and an inner wall surface which defines the valve chamber, includes a third passage for allowing the coolant to flow between the first passage and the second passage, and restricts the coolant from leaking from between the first passage, the second passage, and the third passage and the valve chamber. The sealing member is brought into pressure contact with the outer surface of the valve body and the inner wall surface of the valve chamber at peripheral edges of openings on one side and the other side of the third passage, respectively.

In this example, the peripheral edge of the opening on one side is located in the rotation locus of the opening of the first passage and is in pressure contact with the outer surface of the valve body while being subjected to rotary sliding contact with the valve body. The peripheral edge of the opening on the other side is in pressure contact with the inner wall surface of the valve chamber so as to surround the opening of the second passage. A diameter of the third passage is maximized at both of the opening on one side and the opening on the other side.

As a result, the diameter of the inner wall surface of the sealing member in which the third passage is defined is maximum at both ends, and thus the mold is easily removed in the axial direction. For that reason, the valve device for increasing or decreasing the flow rate of the coolant of the vehicle internal combustion engine is configured such that the sealing member can be easily removed from the mold.

Although the present disclosure has been described with reference to the examples, it should be understood that the present disclosure is not limited to the examples or the structures. The present disclosure includes various modification examples and modifications within the equivalent range. In addition, it should be understood that various combinations or aspects, or other combinations or aspects, in which only one element, one or more elements, or one or less elements are added to the various combinations or aspects, also fall within the scope or technical idea of the present disclosure.

1. A valve device configured to be incorporated in a coolant circuit provided in a vehicle and configured to be driven by an actuator to increase or decrease a flow rate of coolant for a vehicle internal combustion engine, the valve device comprising:
a valve body of a spherical or cylindrical rotary type that has a first passage to cause coolant to flow therethrough, the valve body configured to be rotationally driven by the actuator to change a communication state between the first passage and a second passage according to a rotation angle of the valve body to increase or decrease a flow rate of coolant;
a housing that has the second passage to cause coolant to flow therethrough and defines a valve chamber in which the valve body is rotatably accommodated and in which the second passage is opened; and
a sealing member that is compressed and held between an outer surface of the valve body and an inner wall surface defining the valve chamber, the sealing member having a third passage for allowing coolant to flow between the first passage and the second passage and for restricting leakage of coolant between each of the first passage, the second passage, and the third passage and the valve chamber, wherein
the sealing member is in pressure contact with the outer surface of the valve body and the inner wall surface defining the valve chamber at a peripheral edge of an opening on one side of the third passage and at a peripheral edge of an opening on an other side, respectively,
the peripheral edge of the opening on the one side is located around a locus of rotation of the opening of the first passage and is in pressure contact with the outer surface of the valve body while configured to be subjected to rotary sliding contact with the valve body,
the peripheral edge of the opening on the other side is in pressure contact with the inner wall surface defining the valve chamber to surround the opening of the second passage, and
a diameter of the third passage is maximized at one of the opening on the one side and the opening on the other side.

2. A valve device configured to be incorporated in a coolant circuit provided in a vehicle and configured to be driven by an actuator to increase or decrease a flow rate of coolant for a vehicle internal combustion engine, the valve device comprising:
a valve body of a spherical or cylindrical rotary type that has a first passage to cause coolant to flow therethrough, the valve body configured to be rotationally driven by the actuator to change a communication state between the first passage and a second passage according to a rotation angle of the valve body to increase or decrease a flow rate of coolant;
a housing that has the second passage to cause coolant to flow therethrough and defines a valve chamber in which the valve body is rotatably accommodated and in which the second passage is opened; and
a sealing member that is compressed and held between an outer surface of the valve body and an inner wall surface defining the valve chamber, the sealing member having a third passage for allowing coolant to flow between the first passage and the second passage and for restricting leakage of coolant between each of the first passage, the second passage, and the third passage and the valve chamber, wherein
the sealing member is in pressure contact with the outer surface of the valve body and the inner wall surface defining the valve chamber at a peripheral edge of an opening on one side of the third passage and at a peripheral edge of an opening on an other side, respectively,
the peripheral edge of the opening on the one side is located around a locus of rotation of the opening of the first passage and is in pressure contact with the outer surface of the valve body while configured to be subjected to rotary sliding contact with the valve body,
the peripheral edge of the opening on the other side is in pressure contact with the inner wall surface defining the valve chamber to surround the opening of the second passage, and
a diameter of the third passage is maximized at both of the opening on the one side and the opening on the other side.

3. The valve device according to claim 1, wherein
the sealing member varies in radial thickness according to an axial position of the sealing member.

4. The valve device according to claim 1, wherein
an inside of the valve chamber is configured to be filled with coolant, and
the sealing member includes a valve body-side extension portion that extends from the peripheral edge of the opening on the one side radially outward along the outer surface of the valve body.

5. The valve device according to claim 1, wherein
an inside of the valve chamber is configured to be filled with coolant, and
the sealing member includes a housing-side extension portion that extends from the peripheral edge of the opening on the other side radially outward along the inner wall surface defining the valve chamber.

6. The valve device according to claim 1, wherein
the peripheral edge of the opening on the one side is made of a fluororesin.

7. The valve device according to claim 1, wherein
the sealing member is embedded with a metal ring that is closed throughout its entire circumference and surrounds the third passage.

8. The valve device according to claim 7, wherein
the metal ring is entirely located outside an inner wall of the third passage.

9. The valve device according to claim 1, wherein
the sealing member includes an intermediate extension portion that extends outward in a diameter direction of the third passage between the peripheral edge of the opening on the one side and the peripheral edge of the opening on the other side, and
an area of a portion of the intermediate extension portion exposed to the valve chamber on the housing side is equal to or larger than an area of that on the valve body side.

10. The valve device according to claim 6, wherein the portion made of the fluororesin extends to an inner wall of the third passage and to an outer wall of the sealing member.

11. The valve device according to claim 7, wherein
the metal ring has a bent cross-sectional shape.

12. The valve device according to claim 1, wherein
the sealing member includes a flange that protrudes outward in a diameter direction of the third passage, and
the flange is fixed to the housing by being sandwiched between components forming the housing.
